(19) United States
(12) Patent Application Publication
(10) Pub. No.: US 2012/0046070 A1
(43) Pub. Date: Feb. 23, 2012

(54) MOBILE TERMINAL AND METHOD FOR COMMUNICATING

(75) Inventor: Chi Sun SHIN, Seoul (KR)

(73) Assignee: PANTECH CO., LTD., Seoul (KR)

(21) Appl. No.: 13/195,599

(22) Filed: Aug. 1, 2011

(30) Foreign Application Priority Data
Aug. 18, 2010 (KR) 10-2010-0079785

(51) Int. Cl. H04W 88/02

(52) U.S. Cl. 455/550.1

(57) ABSTRACT

A mobile terminal includes a communication unit to communicate with another terminal or an Internet host, a memory to store sharing information, a setting unit to set permission to transreceive sharing information, and a control unit to transmit a profile of sharing information through the communication unit. A communication method includes setting permission for transreceiving sharing information, receiving a request for transreceiving sharing information, and transmitting a profile of the sharing information.

### CROSS-REFERENCE TO RELATED APPLICATION

This application claims priority from and the benefit under 35 U.S.C. §119(a) of Korean Patent Application No. 10-2010-0079785, filed on Aug. 18, 2010, which is incorporated by reference for all purposes as if fully set forth herein.

### BACKGROUND

1. Field

This disclosure relates to a mobile terminal to transmit and receive sharing information between users and a communication method thereof.

2. Discussion of the Background

With the development of communication technology, methods for establishing a social relationship between individuals have gradually evolved. In particular, a medium called is the “web,” which has appeared with the development of Internet technology, helped to establish a network of personal computers (PCs). With the advent of networks of PCs, a user is able to perform interaction anytime and anywhere with other users through the connected PCs, thereby serving to simultaneously solve time and space constraints of the preceding media. Further, with the development of the Internet technology, a social network service (SNS) was developed to provide a communication service to enable an individual to establish a relationship with others in a virtual space over the Internet and to share a variety of information. Examples of the SNS may include mini homepages, blogs and cafes provided by various organizations such as Cyworld®, Naver® and Daum®. Thus, a user may share information with friends through mini homepages, blogs or cafes, maintain a relationship with friends through communication, or make a community space with those who share similar interests and establish a new relationship.

### SUMMARY

This disclosure is directed to a mobile terminal and method for transmitting and receiving sharing information between users.

Additional features of the invention will be set forth in the description which follows, and in part will be apparent from the description, or may be learned by practice of the invention.

Exemplary embodiments of the present invention provide a mobile terminal including a communication unit to communicate with another terminal or an Internet host; a memory to store sharing information of the mobile terminal; a setting unit to set permission to transreceive sharing information; and a control unit to transmit a profile of sharing information through the communication unit.

Exemplary embodiments of the present invention provide a mobile terminal including a communication unit to communicate with another terminal or an Internet host; a memory to store sharing information; a setting unit to set a sharing configuration of the sharing information, in which the sharing configuration specifies which sharing information is to be transreceived; and a control unit to transmit a profile of sharing information through the communication unit.

Exemplary embodiments of the present invention provide a communication method using a mobile terminal including setting permission for transreceiving sharing information with another terminal; receiving a request for transreceiving sharing information; and transmitting a profile of the sharing information.

It is to be understood that both foregoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of a mobile terminal according to an exemplary embodiment of the invention.

FIG. 2 is a diagram illustrating a communication method according to an is exemplary embodiment of the invention.

FIG. 3a, FIG. 3b, and FIG. 3c are diagrams illustrating a relationship among mobile terminals according to an exemplary embodiment of the invention.

FIG. 4 is a diagram illustrating a range of sharing set in a mobile terminal according to an exemplary embodiment of the invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. may not denote any order or importance, but rather the terms first, second, etc. may be used to distinguish one element from another.

It will be understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be further understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X).

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Throughout the drawings and the detailed description, unless otherwise described, the same drawing reference numerals are understood to refer to the same elements, features, and structures. The relative size and depiction of these elements may be exaggerated for clarity, illustration, and convenience.

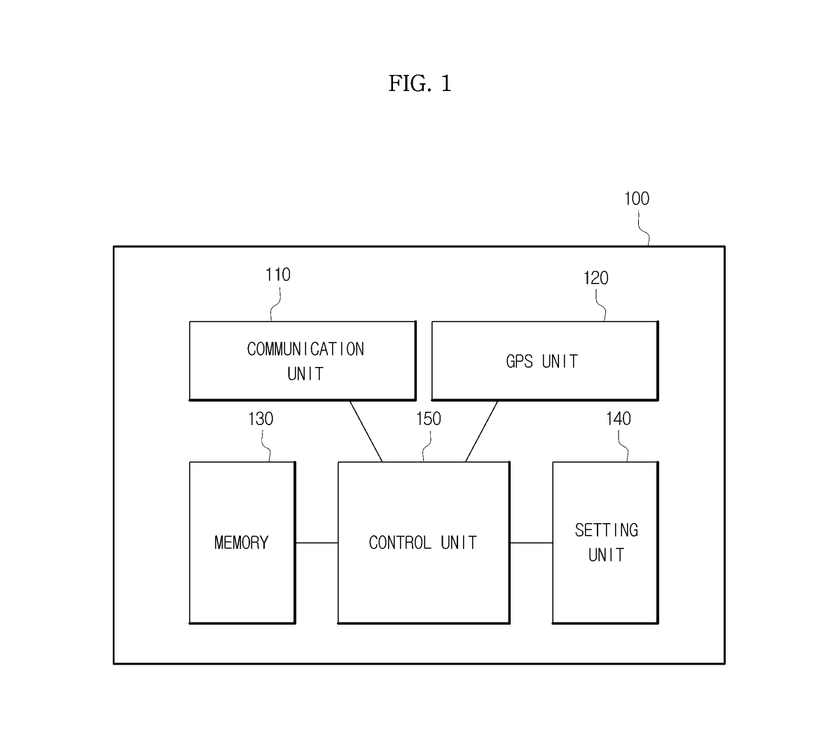

FIG. 1 is a diagram illustrating a configuration of a mobile terminal according to an exemplary embodiment of the invention.

As shown in FIG. 1, the mobile terminal 100 includes a communication unit 110, is a Global Positioning System (GPS) unit 120, a memory 130, a setting unit 140 and a control unit 150. A social network service (SNS) refers to a service that establishes a relationship with persons in a virtual space and establishes a personal network to share information with the persons having a relationship in the virtual space. The mobile terminal 100 may be based on subscription to, or include SNS, but is not limited thereto.

The communication unit 110 may communicate with other terminals or an Internet host. In an example, the mobile terminal 100 may directly communicate with other terminals through a wireless Internet service, such as Wi-Fi®, Blutooth®, ZigBee®, or ultra Wideband® (UWB). In addition, the mobile terminal 100 may communicate with other terminals using a mobile communication system through the Internet host.

The GPS unit 120 may search for positional information of the mobile terminal 100.

The memory 130 may store sharing information of the mobile terminal. In an example, the sharing information may include at least one of environment setting information and application information. The environment setting information may include a photo, an image, a ring tone, a screen saver, a wall paper, a standby screen, and a font style or format of a reception standby screen. The application information may include a program, a widget and an application. If the sharing information of the mobile terminal 100 is changed, the memory 130 may update the stored sharing information with the changed sharing information.

The setting unit 140 may set whether sharing information used in the mobile terminal is allowed or disallowed to be transmitted to the other terminals (allowance/disallowance configuration). In addition, the setting unit 140 may also set a sharing configuration of sharing information stored in the memory 130. In an example, the is allowance/disallowance configuration may indicate whether or not the sharing information used in the mobile terminal is to be transmitted to other terminals. If the allowance/disallowance configuration is set to allow the exchange of sharing information between the mobile terminal and the other terminals, a “sharing relationship” is established between the mobile terminal and the other terminals. Further, the “sharing relationship” may be established whether the exchange of sharing information may be unilateral or bilateral in nature.

The sharing configuration may refer to sharing information that may be transmitted to other terminals. Further, the sharing configuration may also specify individual recipients, group recipients, or a type of recipients. For example, the mobile terminal may be set the sharing configuration to share only photos and ring tones to all of the other mobile terminals in the same SNS within a reference geographic area without special designation. Further, the sharing configuration may specify a type of information to be transmitted. For example, environment setting information of the sharing information may be set to be transmitted in the sharing configuration, which may configure the mobile terminal 100 to transmit its environment setting information to other terminals with a sharing relationship. Further, the mobile terminal 100 may also set the sharing configuration to transmit only specific sharing information, such as a specific application or an image.

If the allowance/disallowance configuration is set, a unidirectional sharing method of transmitting sharing information or a bidirectional sharing method of transmitting sharing information and receiving sharing information of other terminals may be set. In addition, transmitting and/or receiving (“transreceiving”) of sharing information may be limited to reference duration of time set by a user or a system. That is, the reference duration of time to transreceive sharing information may be set according to a user preference or according to is system rules. In an example, transreceiving sharing information allows a mobile terminal to only transmit sharing information, only receive sharing information, or both transmit and receive sharing information.

The sharing configuration may be set differently for different terminals, which may share specific sharing information or according to types of sharing information. In an example, mobile terminal A may set the sharing configuration to receive only ring tones and photos, whereas mobile terminal B may set sharing configuration to receive ring tones, photos, and widgets.

Further, the allowance/disallowance configuration may be set if the mobile terminal 100 joins the SNS or if a request for establishing a friendship is received from other terminals, which join the same SNS.

If a request to receive sharing information is received from a requesting terminal and the requesting terminal is set to be allowed to receive sharing information by the setting unit 140, the control unit 150 may analyze information of the setting unit 140 and transmit a profile of sharing information to the requesting terminal through the communication unit 110. In an example, the profile may be provided as structured data, which may be metadata describing other data. The mobile terminal receiving the sharing information may execute the profile to utilize the received sharing information.

In an example, the control unit 150 may recognize that a request to receive sharing information is received from the other terminals, if the relationship with other terminals is established on the SNS. The mobile terminal 100 may receive sharing information from the other terminals that have a sharing relationship with the mobile terminal 100. In this case, the control unit 150 may receive and execute the profile of the sharing information according to the is sharing configuration of the other terminals.

The control unit 150 may communicate with the other terminals, which may be set to receive the sharing information to establish a sharing relationship. In addition, if the sharing information is changed in the mobile terminal 100, a setting change signal may be transmitted to the other terminals with the appropriate allowance/disallowance configuration setting in order to share the changed sharing information.

The mobile terminal 100 further includes the GPS unit 120, the control unit 150 may search for other terminals approaching to the mobile terminal 100 within a reference area using the positional information searched for by the GPS unit 120. Further, the control unit may control the mobile terminal 100 to transreceive the sharing information with the other terminals identified within the reference area.

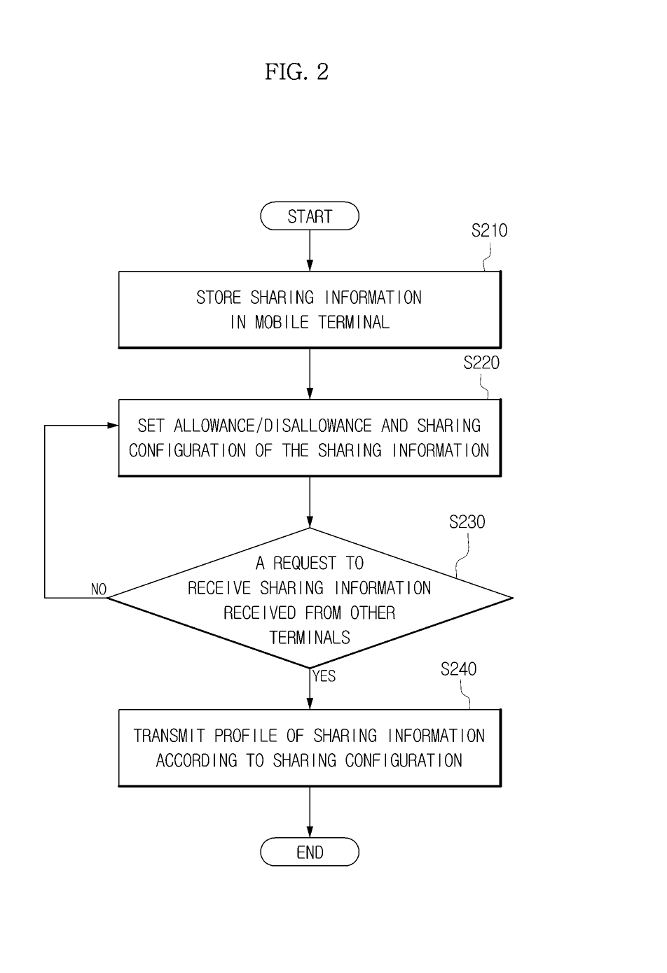

FIG. 2 is a diagram illustrating a communication method according to an exemplary embodiment of the invention.

Referring to FIG. 2, sharing information including at least one of environment setting information and an application information is stored in the mobile terminal (S210), and the allowance/disallowance configuration and a sharing configuration of the sharing information are set (S220). In an example, the allowance/disallowance configuration and the sharing configuration of the sharing information may be set by a user, metadata, data, a sharing information type, and the like. If a request to receive sharing information is received from other terminals, which are set to allow reception of the sharing information (S230), a profile of sharing information corresponding to the sharing configuration is transmitted (S240). The allowance/disallowance configuration and the sharing configuration of the sharing information may be set if the mobile terminal joins a SNS or if a request for establishing a relationship is is received from other terminals in the same SNS. If the sharing information is changed in the mobile terminal, a setting change signal may be transmitted to other terminals, which may share the changed sharing information. If a request to receive the sharing information is received from the other terminals, a profile of the changed sharing information may be further transmitted. The mobile terminal may receive sharing information from other terminals and may additionally receive a profile of sharing information corresponding to the sharing configuration to be executed.

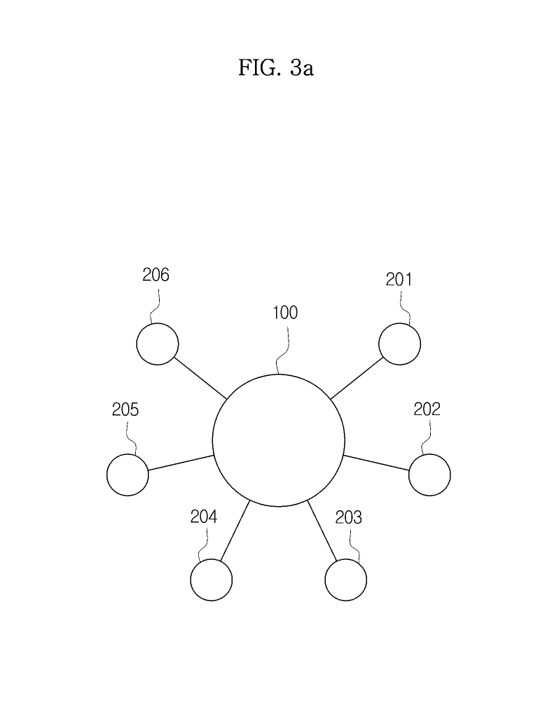

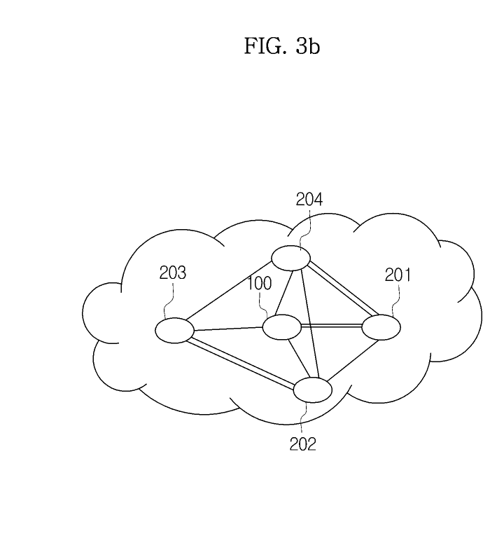

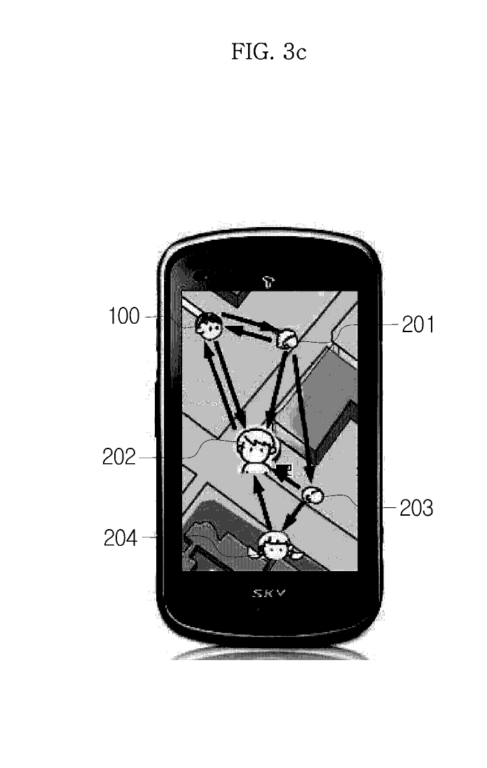

FIG. 3a, FIG. 3b and FIG. 3c are diagrams illustrating a relationship among mobile terminals, according to an exemplary embodiment of the invention.

Referring to FIG. 3a, the sharing information of the mobile terminal 100 may be shared with, for example, six other terminals (first terminal 201, second terminal 202, third terminal 203, fourth terminal 204, fifth terminal 205 and sixth terminal 206). The allowance/disallowance configuration of the mobile terminal 100 with respect to the six other terminals in the provided figure (first terminal 201, second terminal 202, third terminal 203, fourth terminal 204, fifth terminal 205 and sixth terminal 206) may be set based on the SNS. If a request to receive the sharing information is received from the six other terminals (first terminal 201, second terminal 202, third terminal 203, fourth terminal 204, fifth terminal 205 and sixth terminal 206), the sharing information may be shared according to the set allowance/disallowance configuration and the set sharing configuration. In an example, the sharing configuration may be set in accordance to the individual terminal.

Referring to FIG. 3b, the sharing information of the mobile terminal 100 may be shared with, for example, four other terminals (first terminal 201, second terminal 202, third terminal 203 and fourth terminal 204). In addition, sharing information may be shared between is the four other terminals according to the respective sharing configuration of each individual terminal. That is, the sharing information may be transreceived between the mobile terminal 100 and the first terminal 201. In addition, the first terminal 201 may transreceive sharing information with the second terminal 202 and the fourth terminal 204. The second terminal 202 may transreceive sharing information with the third terminal 203.

In an example, if the sharing relationship among the other terminals is extended, another terminal X (not shown) which may transreceive sharing information only with an individual terminal, such as the second terminal 202, may transreceive the sharing information of the mobile terminal 100 through the second terminal 202. Such a result may be accomplished, for example, by executing the sharing information of the mobile terminal 100 in the second terminal 202.

Referring to FIG. 3c, if the mobile terminal 100 includes the GPS unit, the positional information of the mobile terminal 100 may be searched. In addition, the first terminal 201 and the second terminal 202, which may be allowed to transreceive sharing information, located in a reference area may be searched for. If the first terminal 201 and the second terminal 202 are determined to be located in the reference area, the respective identified terminals may be displayed using the identified positional information. In addition, in an example, third terminal 203 and fourth terminal 204, which may not have a sharing relationship with the mobile terminal 100 located with in the reference area may be identified and displayed using their respective identified positional information.

As shown in FIG. 3c, the sharing information of the mobile terminal 100 may be transmitted and received with the first terminal 201 and the second terminal 202 since both the first terminal 201 and the second terminal 202 have established a bidirectional sharing is relationship with the mobile terminal 100. More specifically, the mobile terminal 100 may transmit and receive information from both the first terminal 201 and the second terminal 202 since the mobile terminal 100 has a bidirectional sharing relationship with the respective terminals. Also, the first terminal 201, which may have unidirectional sharing relationships with the second terminal 202 and third terminal 203, transmits its sharing information of the mobile terminal 100 to the second terminal 202 and third terminal 203. The second terminal 202, which may have unidirectional sharing relationships with the third terminal 203 and the fourth terminal 204, receives sharing information from the third terminal 203 and the fourth terminal 204. In addition, the third terminal 203, which may have a unidirectional sharing relationship with the fourth terminal 204, transmits its sharing information to the fourth terminal 204. As a result, even if the fourth terminal 204 does not directly establish a direct relationship with the mobile terminal 100 to receive sharing information of the mobile terminal 100, the fourth terminal 204 may indirectly receive the sharing information of the mobile terminal 100 through the second terminal 202 or the third terminal 203.

In an example, if the other terminal identified in the reference area has already received the current sharing information of the mobile terminal 100, the identified other terminal may refuse receiving of duplicate sharing information.

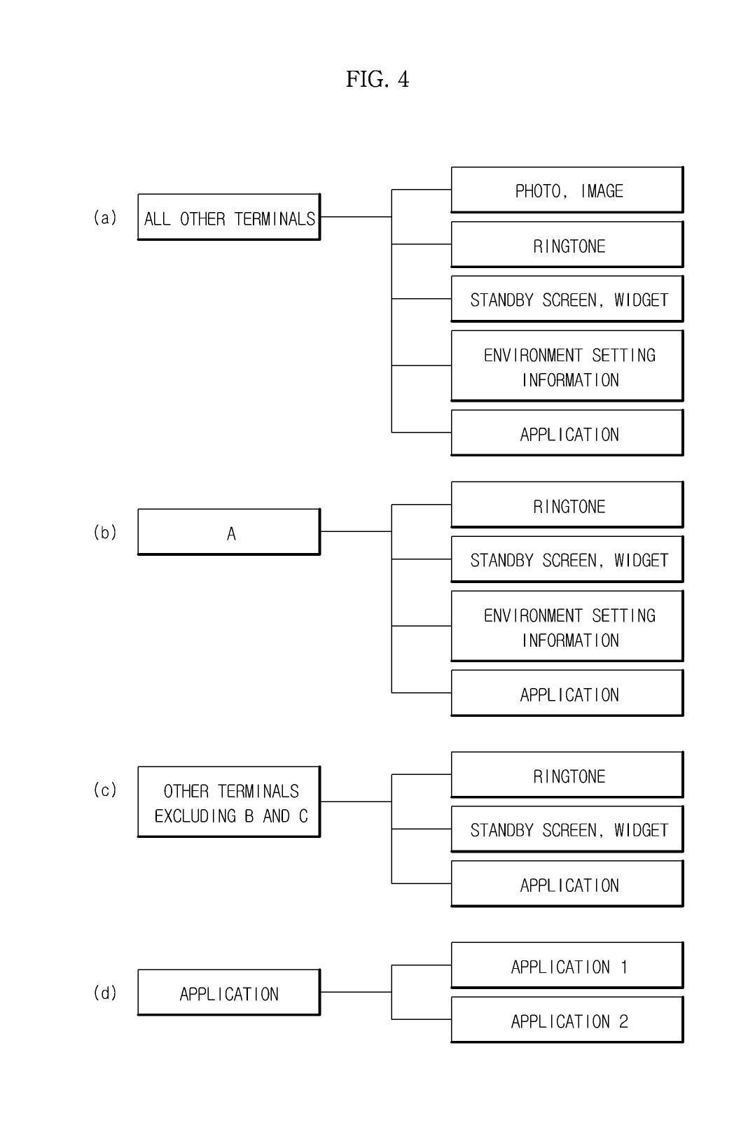

FIG. 4 is a diagram illustrating a set sharing configuration in a mobile terminal according to an exemplary embodiment of the invention.

FIG. 4 (a) is a diagram showing the case where sharing information, such as a photo, an image, a ring tone, a screen saver, a wall paper, a standby screen, and a font style or format of a reception standby screen, a program, a widget, a metadata, and an application are configured as sharing information to be transmitted to other terminals. FIG. 4 (b) is a diagram is showing the case where terminal A has a sharing configuration of sharing information. In this case, terminal A may be allowed to transreceive sharing information. Accordingly, if terminal A requests to receive sharing information of the mobile terminal 100, photos of mobile terminal 100 will not be transmitted. FIG. 4 (c) is a diagram showing the case where all other terminals excluding terminal B and terminal C with a sharing configuration to allow transreceive sharing information, which may be limited to a ring tone, a standby screen, a widget and an application.

FIG. 4 (d) is a diagram showing the case where the sharing configuration is set with respect to specific applications. Accordingly, if a request is made to transreceive sharing information of the mobile terminal including applications, and if sharing relationship allows for sharing of applications, only application 1 and an application 2 may be shared among multitudes of applications that may be present. The mobile terminal may set the sharing configuration of sharing information that may be shared according to various exemplary embodiments, and as a result, the sharing information may be transmitted to other terminals according to the set sharing configuration.

The mobile terminal and the method of controlling the same are not limited to the configuration and the method of the above-described exemplary embodiments and all or parts of the exemplary embodiments may be selectively combined such that various modifications are made.

According to the mobile terminal and the communication method using the same of the embodiments, the sharing information of the mobile terminal may be transreceived between users having a relationship therebetween according to user's intention so as to increase affinity between users and to increase availability of the mobile terminal.

It will be apparent to those skilled in the art that various modifications and is variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
a communication unit to communicate with another terminal or an Internet host;
a memory to store sharing information;
a setting unit to set permission to transreceive sharing information; and
a control unit to transmit a profile of sharing information through the communication unit.

2. The mobile terminal of claim 1, further comprising setting a sharing configuration, the sharing configuration specifying which sharing information is to be transreceived.

3. The mobile terminal of claim 1, wherein the control unit transmits the profile of the sharing information if a request to receive sharing information is received from the other terminal.

4. The mobile terminal of claim 1, wherein the setting unit sets the permission to transreceive the sharing information if the mobile terminal joins a social network service (SNS).

5. The mobile terminal of claim 1, wherein the setting unit sets the permission to transreceive the sharing information if a request for establishing a relationship is received from the other terminal that belongs to the same SNS.

6. The mobile terminal of claim 1, wherein the sharing information comprises at least one of environment setting information and application information,
wherein the environment setting information comprises at least one of a photo, an image, a ring tone, a screen saver, a wall paper, a standby screen, and a font style or format of a reception standby screen, and
the application information comprises a program, a widget, a metadata and an application.

7. The mobile terminal of claim 1, wherein the sharing configuration is set according to the identity of the other terminal.

8. The mobile terminal of claim 1, wherein the sharing configuration is set according to a type of sharing information.

9. The mobile terminal of claim 1, wherein, if the sharing information of the mobile terminal is changed, the sharing information stored in the memory is updated, and the control unit transmits a setting change signal to the other terminal or to the Internet host through the communication unit.

10. The mobile terminal of claim 7, further comprising a Global Positioning System (GPS) unit to search for positional information of the mobile terminal,
wherein the control unit transmits the setting change signal to the other terminal located within a reference area.

11. The mobile terminal of claim 1, wherein the control unit receives and executes a profile of sharing information of the other terminal.

12. The mobile terminal of claim 11, wherein the mobile terminal is set to transreceive the sharing information with the other terminal and the other terminal is set to transreceive the sharing information with the mobile terminal.

13. A mobile terminal, comprising:
a communication unit to communicate with another terminal or an Internet host;
a memory to store sharing information;
a setting unit to set a sharing configuration of the sharing information, wherein the sharing configuration specifies which sharing information is to be transreceived; and
a control unit to transmit a profile of sharing information through the communication unit.

14. A communication method using a mobile terminal, the communication method comprising:
setting permission for transreceiving sharing information with another terminal;
receiving a request for transreceiving sharing information; and
transmitting a profile of the sharing information.

15. The method of claim 14, further comprising setting a sharing configuration of the sharing information.

16. The method of claim 14, wherein the setting of permission for transreceiving of sharing information comprises:
allowing the mobile terminal to join a social network service (SNS); and
setting the sharing configuration of the sharing information.

17. The method of claim 14, wherein the setting of permission for transreceiving sharing information comprises:
receiving a request for establishing a relationship from the other terminal joining the same SNS; and
setting sharing configuration of the sharing information.

18. The method of claim 14, wherein the sharing information comprises at least one of environment setting information and application information,
wherein the environment setting information comprises at least one of a photo, an image, a ring tone, a screen saver, a wall paper, a standby screen, and a font style or format of a reception standby screen, and
the application information comprises a program, a widget, a metadata and an application.

19. The method of claim 14, wherein said transmitting of the profile of the sharing information comprises:
updating the sharing information of the mobile terminal;
transmitting a setting change signal to the other terminal; and
transmitting a profile of the updated sharing information to the other terminal.

20. The method of claim 14, wherein transmitting of the profile of the sharing information comprises:
transmitting a request for transreceiving sharing information from the mobile terminal to the other terminal; and
receiving and executing a profile of sharing information of the other terminal by the mobile terminal.
